(19) United States
(12) Patent Application Publication
(10) Pub. No.: US 2021/0190526 A1
(43) Pub. Date: Jun. 24, 2021

(54) SYSTEM AND METHOD OF GENERATING HIGH-DEFINITION MAP BASED ON CAMERA

(71) Applicants: KOREA EXPRESSWAY CORP., Gimcheon-si (KR); U1GIS, Uiwang-si (KR)

(72) Inventors: In Gu CHOI, Seongnam-si (KR); Jae Hyung Park, Suwon-si (KR); Gi Chang Kim, Anyang-si (KR); Duk Jung Kim, Yongin-si (KR)

(21) Appl. No.: 16/729,448

(22) Filed: Dec. 29, 2019

(30) Foreign Application Priority Data
Dec. 24, 2019 (KR) 10-2019-0174457

(51) Int. Cl. G01C 21/36; G06K 9/00; G06K 9/62

(52) U.S. Cl. CPC G01C 21/367; G06K 9/6211; G06K 9/6232; G06K 9/00805

(57) ABSTRACT

According to an embodiment, there is provided a system creating a high-definition map based on a camera. The system includes at least one map creating device that includes an object recognizing unit recognizing, per frame of the road image, a road facility object including at least one of a GCP object and an ordinary object and a property, a feature point extracting unit extracting a feature point of at least one or more road facility objects from the road image, a feature point tracking unit matching and tracking the feature point in consecutive frames of the road image, a coordinate determining unit obtaining relative spatial coordinates of the feature point to minimize a difference between camera pose information predicted from the tracked feature point and calculated camera pose information, and a correcting unit obtaining absolute spatial coordinates of the feature point.

### CROSS-REFERENCE TO RELATED APPLICATION(S)

This application is based on and claims priority under 35 U.S.C. 119 to Korean Patent Application No. 10-2019-0174457, filed on Dec. 24, 2019, in the Korean Intellectual Property Office, the disclosure of which is herein incorporated by reference in its entirety.

### TECHNICAL FIELD

Various embodiments of the disclosure relate to technology of automatically creating and updating a high-definition map based on a camera(s).

### DESCRIPTION OF RELATED ART

An autonomous vehicle may recognize its position and ambient environment and create a route along which the vehicle may drive safely and efficiently based on the recognized information. The autonomous vehicle may control its steering and speed along the created route.

The autonomous vehicle may recognize its ambient environment (e.g., road facilities, such as lanes or traffic lights or landmarks) using its sensors (e.g., cameras, laser scanners, radar, global navigation satellite system (GNSS), or inertial measurement unit (IMU)) and create a route based on the recognized ambient environment. This way, however, may not work if the ambient environment is difficult to recognize, such as when there are no road lanes or the road environment is very complicated.

A high-definition map provides both 3D high-definition location information and detailed road information, e.g., precise lane information and other various pieces of information necessary for driving, such as the position of traffic lights, the position of stop lines, and whether lanes are changeable lanes or whether intersections are ones permitting a left turn. The autonomous vehicle may drive more safely with the aid of the high-definition map. The high-definition map used for controlling the autonomous vehicle is a three-dimensional (3D) stereoscopic map up to an accuracy of 30 cm for autonomous driving. Whereas the accuracy of ordinary 1/1,000 maps (digital maps) is 70 cm, the high-definition map is as accurate as 25 cm or less. This is ten times as accurate as navigation maps whose accuracy is 1 m to 2.5 m.

The high-definition map is also utilized for gathering event information on the road based on precise location information via a dashboard camera that is equipped with various safety functionalities, such as forward collision warning or lane departure warning. The high-definition map may also be used for information exchange for camera-equipped connected cars and precise positioning by gathering event information and information for various road facilities using various camera-equipped vehicles.

To build up a high-definition map, the mobile mapping system is used. The MMS is a mobile 3D spatial information system incorporating a digital camera, a 3D laser scanner system (LiDAR), GNSS, and IMU. The MMS is equipped in a moving body, e.g., a vehicle. An MMS-equipped vehicle may perform 360-degree, omni-directional capturing or recording while driving 40 km to 100 km per hour. The MMS is a very expensive piece of equipment. Creation and update of a high-definition map using the MMS consumes lots of labor and costs. The MMS cannot quickly update the high-definition map when changes are made to the road condition and may rather harm the safety of autonomous vehicles that rely on the high-definition map for autonomous driving.

Thus, a need exists for new technology that may decrease communication loads and costs in creating a high-definition map.

### SUMMARY

The high-definition map creating system requires many probe vehicles to update the high-definition map in real-time responsive to road changes and is thus very cost-consuming for maintenance. Since the MMS gathers lots of data per hour, it may have difficulty in updating the high-definition map by real-time receiving and processing data received from the probe vehicles.

According to various embodiments of the disclosure, there may be provided an automated, camera-based high-definition map creating system and method that may reduce costs for creating a high-definition map.

According to an embodiment, there is provided a system creating a high-definition map based on a camera. The system includes at least one or more map creating devices creating a high-definition map using a road image including an image of a road facility object captured by a camera fixed to a probe vehicle. Each of the at least one or more high-definition maps includes an object recognizing unit recognizing, per frame of the road image, a road facility object including at least one of a ground control point (GCP) object and an ordinary object and a property, a feature point extracting unit extracting a feature point of at least one or more road facility objects from the road image, a feature point tracking unit matching and tracking the feature point in consecutive frames of the road image, a coordinate determining unit obtaining relative spatial coordinates of the feature point to minimize a difference between camera pose information predicted from the tracked feature point and calculated camera pose information, and a correcting unit obtaining absolute spatial coordinates of the feature point by correcting the relative spatial coordinates of the feature point based on a coordinate point whose absolute spatial coordinates are known around the GCP object when the GCP object is recognized.

The system may further include a map creating server gathering absolute spatial coordinates of feature point and a property of each road facility object from the at least one or more map creating devices to create the high-definition map.

Each of the at least one or more map creating devices may further include a key frame determining unit determining that a frame when the relative spatial coordinates of the feature point are moved a reference range or more between consecutive frames of the road image is a key frame and controlling the coordinate determining unit to perform computation only in the key frame.

The key frame determining unit may determine that the same feature point present in a plurality of key frames is a tie point and deletes feature points except for the determined tie point.

The correcting unit, if the probe vehicle passes again through an area which the probe vehicle has previously passed through, may detect a loop route from a route along which the probe vehicle has travelled and corrects absolute spatial coordinates of a feature point of a road facility object present in the loop route based on a difference between absolute spatial coordinates of the feature point determined in the past in the area and absolute spatial coordinates of the feature point currently determined.

The map creating server may analyze a route which at least two or more probe vehicles have passed through to detect an overlapping route and correct spatial coordinates of a feature point of a road facility object present in the overlapping route based on a difference between absolute spatial coordinates of the feature point determined by the probe vehicles.

The road facility object may be a road object positioned on a road or a mid-air object positioned in the air. The coordinate determining unit may determine whether the road facility object is the road object or the mid-air object based on a property of the road facility object and obtain absolute spatial coordinates of the road object in each frame of the road image using a homography transform on at least four coordinate points whose spatial coordinates have been known around the GCP object.

The GCP object may include at least one of a manhole cover, a fire hydrant, an end or connector of a road facility, or a road drainage structure.

According to an embodiment, there is provided a method of creating a high-definition map based on a camera. The method may create a high-definition map using a road image including an image of a road facility object captured by a camera fixed to a probe vehicle. The method includes recognizing, per frame of the road image, a road facility object including at least one of a ground control point (GCP) object and an ordinary object and a property, extracting a feature point of at least one or more road facility objects from the road image, matching and tracking the feature point in consecutive frames of the road image, obtaining relative spatial coordinates of the feature point to minimize a difference between camera pose information predicted from the tracked feature point and calculated camera pose information, and obtaining absolute spatial coordinates of the feature point by correcting the relative spatial coordinates of the feature point based on a coordinate point whose absolute spatial coordinates are known around the GCP object when the GCP object is recognized.

The method may further include gathering, by a map creating server, absolute spatial coordinates of feature point and a property of each road facility object from at least one or more probe vehicles to create the high-definition map.

The method may further include determining that a frame when the relative spatial coordinates of the feature point are moved a reference range or more between consecutive frames of the road image is a key frame and obtaining the relative spatial coordinates and absolute spatial coordinates of the feature point only in the key frame.

The method may further include determining that the same feature point present in a plurality of key frames is a tie point and deleting feature points except for the determined tie point.

The method may further include, if the probe vehicle passes again through an area which the probe vehicle has previously passed through, detecting a loop route from a route along which the probe vehicle has travelled and correcting absolute spatial coordinates of a feature point of a road facility object present in the loop route based on a difference between absolute spatial coordinates of the feature point determined in the past in the area and absolute spatial coordinates of the feature point currently determined.

The method may further include analyzing a route which at least two or more probe vehicles have passed through to detect an overlapping route and correcting spatial coordinates of a feature point of a road facility object present in the overlapping route based on a difference between absolute spatial coordinates of the feature point determined by the probe vehicles.

The road facility object may be a road object positioned on a road or a mid-air object positioned in the air. The method may further include determining whether the road facility object is the road object or the mid-air object based on a property of the road facility object and obtaining absolute spatial coordinates of the road object in each frame of the road image using a homography transform on at least four coordinate points whose spatial coordinates have been known around the GCP object.

The GCP object may include at least one of a manhole cover, a fire hydrant, an end or connector of a road facility, or a road drainage structure.

Various embodiments of the disclosure recognize road facility objects and create a high-definition map using only GCP information and feature points corresponding to the recognized objects, thus creating a high-definition map in a quick and exact manner and reducing costs for implementing probe vehicles and hence saving costs for creating a high-definition map. Other various effects may be provided directly or indirectly in the disclosure.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a view illustrating an automated, camera-based high-definition map creating system according to an embodiment;

FIG. 2 is a block diagram illustrating a map creating device according to an embodiment;

FIG. 3 is a block diagram illustrating a map creating unit in a map creating device according to an embodiment;

FIG. 4 is a block diagram illustrating a map creating server according to an embodiment;

FIG. 5 is a block diagram illustrating a map correcting unit of a map creating server according to an embodiment;

FIG. 6 is a flowchart illustrating an automated, camera-based high-definition map creating method according to an embodiment;

FIG. 7 is a flowchart illustrating an automated, camera-based high-definition map creating method according to an embodiment; and

FIG. 8 is a view illustrating information flows in a map creating device and a map creating server according to an embodiment.

The same or similar reference denotations may be used to refer to the same or similar elements throughout the specification and the drawings.

### DETAILED DESCRIPTION OF EXEMPLARY EMBODIMENTS

Some terms as used herein may be defined as follows.

‘Road facility object’ refers to a facility included in a precise map and includes at least one of pavement markings, warning signs, regulatory signs, mandatory signs, additional signs, traffic signs, traffic lights, traffic lights, poles, manholes, curbs, median barriers, fire hydrants, and/or buildings. Road facility objects may be fixed and displayed on the road or may be facilities in the air, such as traffic lights, some feature points of buildings, or signs, or may be displayed on such facilities.

‘Road facility object’ may refer to any kind of facility that may be included in a precise map and its concept may encompass pavement markings, warning signs, regulatory signs, mandatory signs, additional signs, traffic signs, traffic lights, traffic lights, poles, manholes, curbs, median barriers, fire hydrants, buildings, and/or building signs. In the disclosure, at least one or more of such objects may be used. For example, road center lines, solid lines, broken lines, turn-left arrows, drive straight ahead arrows, slow-down diamond-shaped markings, speed limit zone markings, or any other various kinds of pavement markings which may be painted on the road, traffic lights, poles, manholes, fire hydrants, curbs, median barriers, sign boards, or any other various road structures which are installed on the road and various signs or markings on the structures, or traffic lights, various kinds of signs or markings on traffic control devices or traffic lights, and buildings may belong to facility objects.

‘Ground control point (GCP)’ refers to a coordinate point used for absolute orientation, whose exact coordinates have been known. In the disclosure, among various road facility objects, manhole covers, fire hydrants, ends or connectors of road facilities, or road drainage structures may be used as GCP objects.

‘High-definition road map’ refers to a map information database which includes and stores the respective properties (or attributes) of road facility objects and spatial coordinate information for the feature points of road facility objects. The respective feature points of road facility objects included in the high-definition map may correspond to spatial coordinate information for the feature points in a one-to-one correspondence manner. As used herein, “feature point of a road facility object” refers to a featuring point in the road facility. For example, in an image of a road facility object, the inside or outside vertexes whose boundary is noticeable by clear changes in color and brightness or noticeable points in the contour may be feature points. Thus, a feature point of a road facility object may be a vertex or any point in an edge of the road facility object.

The high-definition map is an electronic map created with all road facility object information necessary for autonomous driving and is used for autonomous vehicles, connected cars, traffic control, and road maintenance.

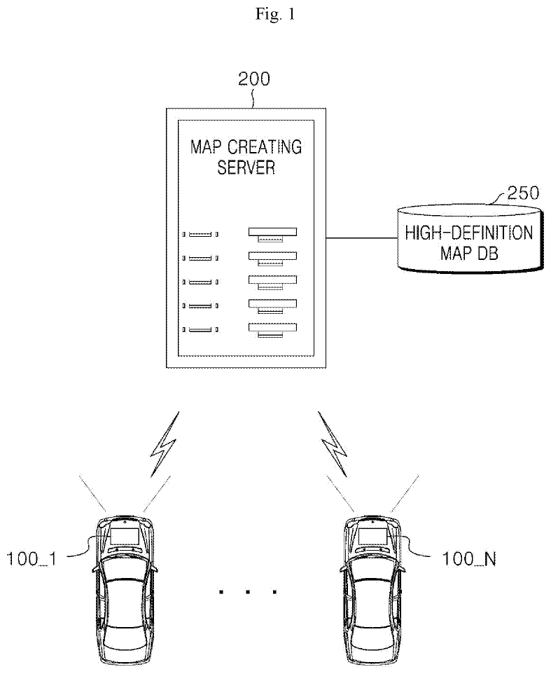

FIG. 1 is a view illustrating an automated, camera-based high-definition map creating system according to an embodiment.

Referring to FIG. 1, an automated, camera-based high-definition map creating system includes at least one or more map creating devices 100_1 to 100_n and a map creating server 200.

Each map creating device 100_1 to 100_n is a device that is mounted in a probe vehicle to create a high-definition map. The map creating device 100_1 to 100_n creates a high-definition map using road images including images of road facility objects captured by the camera fixed to the probe vehicle.

High-definition road map information created by the high-definition map created by the map creating device 100_1 to 100_n is transmitted to the map creating server 200. The map creating server 200 compiles and merges the high-definition map information gathered from each map creating device 100_1 to 100_n, finally completing a high-definition map for the whole area.

The map creating device 100_1 to 100_n needs to be aware of the spatial coordinates of a GCP object or a specific road facility object near an initial start point to grasp the location of the camera at the initial start point.

An orthoimage is created by aerial-photographing a specific area or an area with a GCP object. The spatial coordinates of all the pixels included in the orthoimage are determined with respect to a ground reference point included in the aerial image based on real-time kinematic (RTK) positioning. In such a way, absolute spatial coordinates may be assigned to each road facility object around the GCP object in the specific area or the area with the GCP object. The feature point of the absolute spatial coordinates-assigned road facility object is defined herein as a coordinate point.

The map creating device 100 may extract and recognize at least one or more road facility objects, which correspond to ground control points (GCPs), or ordinary objects (e.g., objects around GCP objects) whose spatial coordinates have already been known from the road image, identify the property of the at least one or more recognized road facility objects and spatial coordinates of the coordinate points, and determine the location (e.g., spatial coordinates) of the camera at the time of capturing the road image based on the spatial coordinates of the coordinate points of the road facility objects.

The map creating device 100 may determine the spatial coordinates of the feature points and the property of all the road facility objects in the road image based on the determined location and create a database of the property of all the road facility objects and spatial coordinates of feature points, thereby creating a high-definition map.

Then, after the camera-equipped probe vehicle drives a predetermined distance, the camera may capture in the direction of the car driving to thereby create a subsequent road image including at least one or more road facility objects. In this case, the subsequent road image includes some of the road facility objects whose spatial coordinates have been determined via the prior image.

The map creating device 100 may receive and obtain the subsequent road image from the camera. The subsequent road image may be an image resultant from capturing the road in the driving direction after the vehicle has driven a predetermined distance from the prior capturing position. The subsequent road image may include at least one or more of at least one or more reference road facility objects (also referred to as GCP objects) or road facility objects for which the feature point spatial coordinates have been known in the road image.

The map creating device 100 may identify the location of camera capturing (e.g., the location of the vehicle) based on the spatial coordinates of the feature points of the reference road facility objects (also referred to as GCP objects) or road facility objects whose spatial coordinates have been known in the subsequent road image.

In this case, the map creating device 100 may determine the spatial coordinates of the feature points of all the road facility objects included in the subsequent road image based on the spatial coordinates of the feature points of the GCP objects or road facility objects whose spatial coordinates have been known and create a database thereof, thereby creating a high-definition map.

The map creating device 100 may determine the property and feature point spatial coordinates of other road facility objects based on the road facility objects whose spatial coordinates have been known and create a database of the determined object properties and spatial coordinates, thereby creating a high-definition map. The above-described process may be repeated whenever the vehicle drives a predetermined distance. In such a way, a high-definition map for a broader area and even a nationwide high-definition map may be created. Thus, the map creating device 100 may secure data for creating or updating a high-definition map using camera-equipped vehicles without the need for a high-cost MMS.

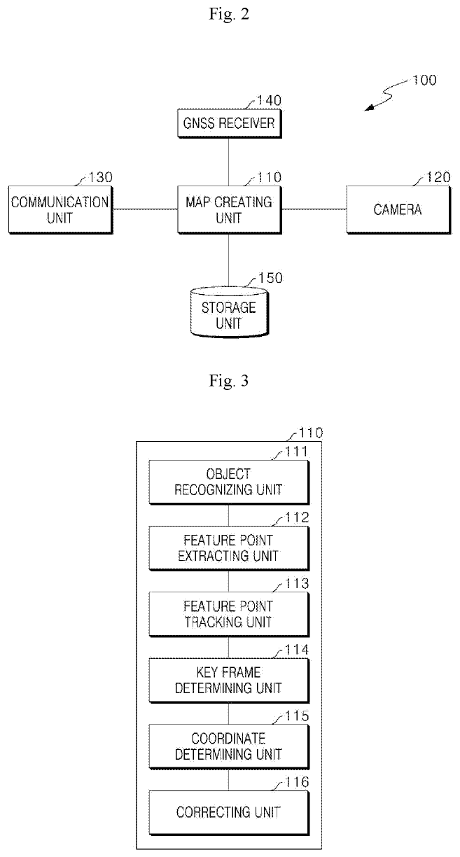

FIG. 2 is a block diagram illustrating a map creating device 100 according to an embodiment.

Referring to FIG. 2, according to an embodiment, a map creating device 100 includes a map creating unit 110. The map creating device 100 may further include at least one of a camera 120, a communication unit 130, a GNSS receiver 140, and a storage unit 150. Although not shown in FIG. 2, the map creating device 100 may further include an inertial measurement unit (IMU).

The map creating unit 110 creates a high-definition map using a road image including images of road facility objects captured by a camera.

The camera 120 is fixed to a probe vehicle. The camera 120 captures in the forward direction of the vehicle to create a road image including road facility object images. The created road image is transferred to the map creating device 100.

The communication unit 130 communicates with the map creating server 200. The communication unit 130 transmits the high-definition map created by the map creating device 100 and the road image captured by the camera 120 to the map creating server 200. As described below, an image resultant from extracting only key frames from the road image may be transmitted.

The GNSS receiver 140 periodically obtains GNSS location information. In particular, the GNSS receiver 140 may obtain the GNSS location information for the capturing location of the camera 120 at the time synchronized with the capturing time of the camera 120. The global navigation satellite system (GNSS) is a positioning or locating system using satellites and may use the global positioning system (GPS).

The storage unit 150 stores the road image captured by the camera 120 and the high-definition map created by the map creating device 100.

FIG. 3 is a block diagram illustrating a map creating unit in a map creating device according to an embodiment.

Referring to FIG. 3, according to an embodiment, a map creating device 100 may include an object recognizing unit 111, a feature point extracting unit 112, a feature point tracking unit 113, a coordinate determining unit 115, and a correcting unit 116. The map creating device 100 may further include a key frame determining unit 114.

The object recognizing unit 111 recognizes road facility objects including at least one of GCP objects and ordinary objects from each frame and the properties of the road facility objects. The object recognizing unit 111 recognizes road facility objects and their properties from the road image via machine learning, including deep learning, or other various image processing schemes.

The object recognizing unit 111 may correct distortions in the road image which may occur due to the lenses, detect moving objects, e.g., vehicles, motorcycles, or humans, from the road image, and remove or exclude the moving objects, thereby allowing the stationary road facility objects on the ground or in the air to be efficiently recognized.

The feature point extracting unit 112 extracts the feature points of at least one or more road facility objects from the road image. The feature point extracting unit 112 extracts myriad feature points of road facility objects recognized by the object recognizing unit 111. To detect feature points, various algorithms may apply which include, but are not limited to, features from accelerated segment test (FAST), oriented FAST and rotated BRIEF (ORB), scale-invariant feature transform (SIFT), adaptive and generic accelerated segment test (AGAST), speeded-up robust features (SURF), binary robust independent elementary features (BRIEF), Harris corner, and/or Shi-Tomasi corner.

The feature point tracking unit 113 matches and tracks the feature points of the road facility objects extracted from each frame of the road image on each consecutive frame.

The key frame determining unit 114 may determine a key frame in each frame of the road image to reduce the amount of computation of the coordinate determining unit 115 and perform control so that the computation of the pose obtaining unit and the spatial coordinates determining unit is performed only in the determined key frame.

To that end, the key frame determining unit 114 analyzes the feature points of each frame in the road image and determine that the frame when the relative spatial coordinates of the feature point has moved a reference range or more between the frames is the key frame. Since ‘key frame’ means a frame where a large change occurs among the image frames of the road image, the frame where the relative spatial coordinates of the feature point has moved the reference range or more may be determined to be the key frame. The case where the relative spatial coordinates of the feature point has moved the reference range or more means that the vehicle moves a predetermined distance or more so that the change in position of the feature point in the road image has shifted the reference range or more. Tracking the feature point of the road image which makes no or little change as when the vehicle stops or moves slowly may be meaningless. Thus, the computation loads may be reduced by determining that the frame after the vehicle has moved a predetermined distance is the key frame and tracking the feature points using only the key frame.

The key frame determining unit 114 may further reduce the computation loads by determining that the same feature point present in a plurality of key frames is a tie point and deleting the other feature points than the determined tie point.

The coordinate determining unit 115 obtains relative spatial coordinates of the feature point to minimize a difference between camera pose information predicted from the tracked feature point and calculated camera pose information. At this time, the coordinate determining unit 115 may determine the relative spatial coordinates or absolute spatial coordinates of the feature point of the road facility object per frame of the road image.

The correcting unit 116, upon recognizing a GCP object, obtains the absolute spatial coordinates of the feature point by correcting the relative spatial coordinates of the feature point with respect to the coordinate point of the GCP object whose spatial coordinates has been known.

Since the road facility object is a fixed object on the ground or in the air, the road facility object present in the road image may be positioned on the road or in the air.

The coordinate determining unit 115 may identify whether the road facility object included in the road image is a road object which is positioned on the road or a mid-air object which is positioned in the air based on the properties of the road facility object.

If the position of the road facility object is determined, the coordinate determining unit 115 may determine the spatial coordinates of the feature point of the road facility object in two methods as follows.

The first method may determine both the spatial coordinates of the road object and the spatial coordinates of the mid-air object. In the first method, the spatial coordinates of each object whose spatial coordinates are not known are determined based on the camera pose information in each frame of the road image.

If each feature point is tracked in the continuous frames or key frame in the road image, the correspondence between the image frames may be traced so that the position of each feature point or the pose information for the camera may be predicted.

In this case, a difference may occur between the position of the feature point or the camera pose information, which is predicted from the correspondence between image frames, and the position of each feature point or camera pose information, which is computed from each frame of the road image and, in the process of minimizing the difference, the relative spatial coordinates of each feature point in each frame and relative camera pose information may be obtained.

The obtained spatial coordinates of the feature point and camera pose information may be represented as a value relative to a reference position or a reference pose. Thus, if the absolute spatial coordinates of a feature point or exact pose information for the camera is known at a certain time, the obtained relative spatial coordinates of feature point and the relative pose information for the camera may be corrected to a precise value.

Coordinate points whose absolute spatial coordinates have already been known are present in the GCP object, and the properties of the GCP object and information for coordinate points whose absolute spatial coordinates may be known in the GCP object are previously stored in the map creating device.

Thus, if the GCP object is recognized, the coordinate determining unit 115 detects at least four coordinate points whose spatial coordinates have been known and obtains the camera pose information using a pin hole camera model from the at least four coordinate points detected.

The camera pose information is information for the position and pose of the camera, and the camera pose information includes information for the spatial coordinates, the roll, pitch, and yaw of the camera.

External parameters of the camera may be obtained via the pin hole camera model based on Equation 1.

sp_{c}=K[R|T]p_{w}[Equation 1]

In Equation 1, K is the intrinsic parameter of the camera, [R|T] is the extrinsic parameter of the camera, P_{w} is the 3D spatial coordinates, P_{c} is the 2D camera coordinates corresponding to the 3D spatial coordinates, and s is the image scale factor. The extrinsic parameter of the camera is a parameter that specifies the transform relationship between the 2D camera coordinating system and the 3D world coordinating system. The extrinsic parameter includes information for the pose (roll, pitch, and yaw of the camera) and the installation position of the camera and is expressed with the rotation matrix R and the translation matrix T between the two coordinating systems.

Equation 1 may be represented as Equation 2.

$$s [ \begin{matrix}u \\ v \\ 1\end{matrix} ] = [ \begin{matrix}{f}_{x} & γ & {u}_{0} \\ 0 & {f}_{y} & {v}_{0} \\ 0 & 0 & 1\end{matrix} ] [ \begin{matrix}{r}_{11} & {r}_{12} & {r}_{12} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] \qquad [ Equation 2 ]$$

Here, (x, y, z) is the 3D spatial coordinates of the world coordinating system, fₓ is the focal length in the x axis direction, G is the focal length in the γ axis direction, (u, v) is the 2D camera coordinates of the camera coordinating system, γ is the skew coefficient which indicates the degree of y-axis tilt of the image sensor cell array, and (u₀, v₀) is the camera coordinates of the principal point of the camera.

Since the absolute spatial coordinates of at least four points in the frame of the road image are known, and the intrinsic parameter of the camera and image scale factor may be known, the camera pose information may be obtained via the above equations.

The correcting unit 116 may correct the relative spatial coordinates of each feature point in the frame with respect to the camera pose information so obtained, thereby obtaining the absolute spatial coordinates. As described below, the correcting unit 116 may correct the spatial coordinates of feature points using other schemes.

The second method is to determine the spatial coordinates of the road object positioned on the road. In the second method, the spatial coordinates of each road object whose spatial coordinates is not known in each frame of the road image are determined via homography transform.

Homography may be used for positioning of the probe vehicle and the spatial coordinates of the road object. If one plane is projected onto another plane, a predetermined transform relationship is formed between the projected corresponding points, and such a transform relationship is called homography.

Since a homography transform function is a function that defines the relationship between each dimensional image and one absolute coordinating system (absolute spatial coordinates), the homography transform function may transform the image coordinates of the camera into the spatial coordinates of the absolute coordinating system. From the spatial coordinates of the four points whose spatial coordinates have previously been known and the camera coordinates in the points, the spatial coordinates of all of the other points of the road may be computed using the transform relationship.

As described above, the correcting unit 116 performs final correction on the absolute spatial coordinates of the road facility object via the process of correcting the camera pose information, and the feature points of the road facility objects gathered per frame in the road image.

Correction of the spatial coordinates of the road facility object may be performed using four schemes as follows.

The first scheme is a local bundle adjustment (LBA) scheme that bundles up the per-frame camera pose information and performs correction via comparison between the actually computed value and the predicted value.

In the second scheme, if a new GCP object is discovered after the initial start point in the road image, the determined spatial coordinates of feature point are corrected based on the absolute spatial coordinates of the new GCP object. The spatial coordinates of the feature points previously obtained may be simultaneously corrected based on the error between the spatial coordinates determined by the coordinate determining unit 115 and the absolute spatial coordinates of the newly recognized GCP object.

In the third scheme, if the probe vehicle, after starting driving, passes again the area that it has passed before, a loop route forming a loop from the route that the probe vehicle has passed is determined, and the absolute spatial coordinates of the feature points of the road facility objects present in the loop route may be corrected based on the difference between the absolute spatial coordinates of the feature point of the road facility object determined in the past and the absolute spatial coordinates of the feature point currently determined.

In the fourth and last scheme, a route which at least two or more probe vehicles have passed through is analyzed to detect an overlapping route, which overlaps in route and direction, and the spatial coordinates of the feature point of the road facility object present in the overlapping route may be corrected based on the difference in spatial coordinates at the overlapping route determined by each probe vehicle. The fourth scheme requires analysis of the vehicle routes with a high-definition map created by several map creating devices 100 and, thus, is used primarily in the map creating server 200.

According to an embodiment, the spatial coordinates of the feature point of the road facility object may be corrected using at least one of the four schemes. As described below, correction of spatial coordinates may be performed by the map creating device 100 mounted on the vehicle or by the map creating server 200.

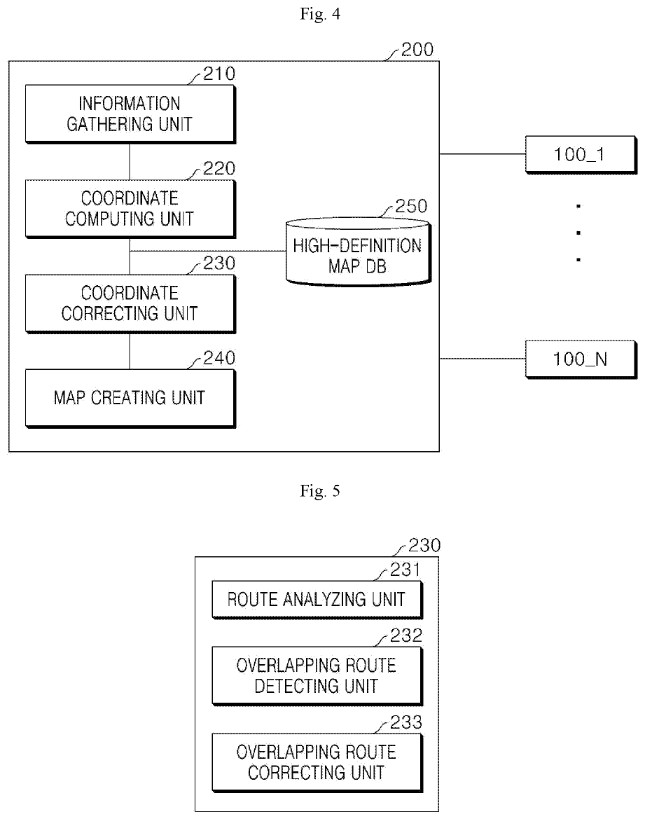

FIG. 4 is a block diagram illustrating a map creating server 200 according to an embodiment.

Referring to FIG. 4, the map creating server 200 includes at least one of an information gathering unit 210, a coordinate computing unit 220, a coordinate correcting unit 230, a map creating unit 240, and a high-definition map database (DB) 250.

The information gathering unit 210 gathers information for a high-definition map and a road image from each map creating device 100_1 to 100_n. The information for the high-definition map includes the properties of each road facility object and the absolute spatial coordinates of feature points. The information gathering unit 210 may receive road images constituted only of key frames or receive road images resulting from deleting feature points except for tie points so as to reduce computation loads.

The coordinate computing unit 220 may compute the spatial coordinates of each road facility object from the road image received from each map creating device 100_1 to 100_n. The map creating server 200 may receive, from each map creating device 100_1 to 100_n, and store the high-definition map, or the map creating server 200 may receive the road image from each map creating device 100_1 to 100_n and compute the spatial coordinates of each road facility object from the received road image.

Although not shown in FIG. 4, the coordinate computing unit 220 may, to that end, include components that perform the same functions as those of the object recognizing unit 111, the feature point extracting unit 112, the feature point tracking unit 113, the key frame determining unit 114, and the coordinate determining unit 115 of FIG. 3.

The coordinate correcting unit 230 may correct the spatial coordinates of the road facility object computed by the coordinate computing unit 220 or the spatial coordinates of each road facility object received from each map creating device 100_1 to 100_n. The coordinate correcting unit 230 may use the above-described four schemes for correcting spatial coordinates.

The map creating unit 240 may merge the high-definition map information gathered from each map creating device 100_1 to 100_n to complete a full final high-definition map.

The high-definition map information merged by the map creating unit 240 may be created into a database that is then stored in the high-definition map DB 250.

FIG. 5 is a block diagram illustrating a map correcting unit of a map creating server according to an embodiment.

Referring to FIG. 5, the coordinate correcting unit 230 of the map creating server 200 includes at least one of a route analyzing unit 231, an overlapping route detecting unit 232, and an overlapping route correcting unit 233.

The route analyzing unit 231 analyzes the route which at least two or more probe vehicles equipped with the map creating device 100_1 to 100_n have passed. The overlapping route detecting unit 232 detects an overlapping route that overlaps in route and direction. The overlapping route correcting unit 233 corrects the spatial coordinates of the feature point of the road facility object present in the detected overlapping route based on the difference in the absolute spatial coordinates of the feature point determined by each map creating device 100_1 to 100_n.

If the spatial coordinates of the feature point of the road facility object present in the detected overlapping route are corrected, the coordinate correcting unit 230 may extract all the map creating devices that have passed the overlapping route and perform correction on the whole route that each map creating device has passed based on the corrected spatial coordinates in the overlapping route.

An automated, camera-based high-definition map creating method is described below according to an embodiment. The automated, camera-based high-definition map creation method may be performed by the automated, camera-based high-definition map creation system and map creating device described above.

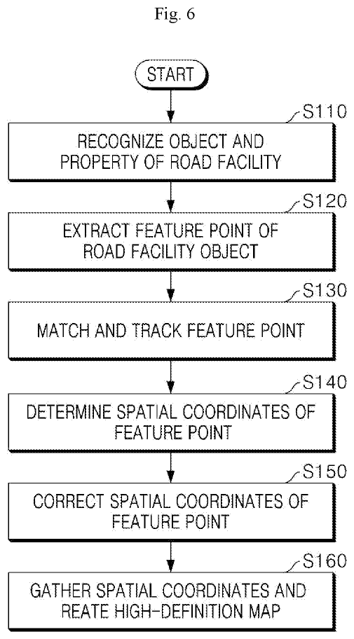

FIG. 6 is a flowchart illustrating an automated, camera-based high-definition map creating method according to an embodiment.

The map creating device 100 recognizes, per frame of the road image, the properties and road facility objects including at least one of GCP objects and ordinary objects from each frame of the road image (S110). Machine learning including deep learning or other various image processing schemes may be used to recognize the road facility objects.

Then, the map creating device 100 extracts the feature points of at least one or more road facility objects from the road image (S120).

Then, the map creating device 100 matches and tracks the feature points of all the road facility objects extracted from each frame of the road image on each consecutive frame (S130).

After matching the feature points, the map creating device 100 obtains relative spatial coordinates of the feature point to minimize a difference between camera pose information predicted from the tracked feature point and calculated camera pose information (S140).

Then, the map creating device 100, upon recognizing a GCP object, obtains the absolute spatial coordinates of the feature point by correcting the relative spatial coordinates of the feature point with respect to the coordinate point whose absolute spatial coordinates has been known around the GCP object (S150).

The properties of each road facility object and the corrected spatial coordinates of feature points are transmitted to the map creating server 200, and the road image may also be transmitted to the map creating server 200.

The map creating server 200 may gather the properties of each road facility object and the corrected spatial coordinates of feature points from at least one or more map creating devices 100 and merge them, thereby completing a full high-definition map (S160).

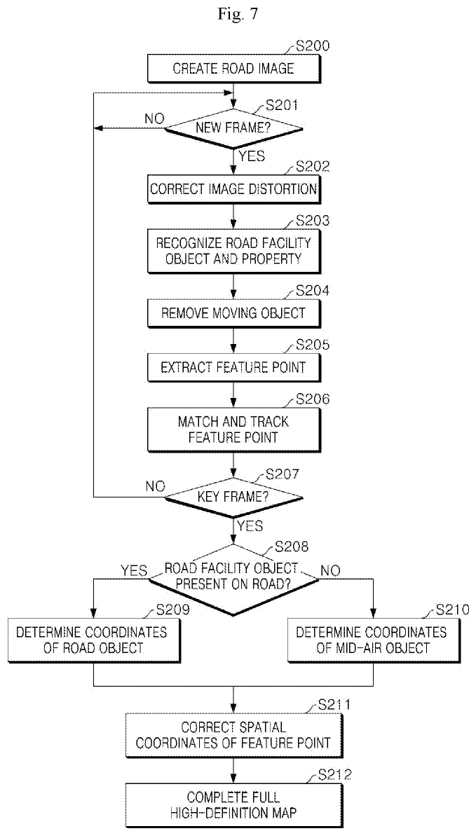

FIG. 7 is a flowchart illustrating a high-definition map creating method according to an embodiment.

The camera mounted on each map creating device 100 captures in the forward direction of the vehicle, generating a road image including images of at least one or more road facility objects (S200). The created road image is transferred to the map creating device 100.

The map creating device 100 analyzes each frame of the road image and, if the current frame is a new frame (S201), corrects image distortion in the current frame (S202). If the current frame is not a new frame, the map creating device 100 continues to receive the road images.

The map creating device 100 recognizes road facility objects including at least one of GCP objects and ordinary objects from the current frame and the properties of the road facility objects (S203).

The map creating device 100 simultaneously detects and remove moving objects, e.g., vehicles, motorcycles, or persons, from the current frame of the road image (S204).

Then, the map creating device 100 extracts the feature points of at least one or more road facility objects from the current frame of the road image (S205).

Then, the map creating device 100 matches the feature points of all the road facility objects extracted from the current frame with those in the prior frame and track them (S206).

At this time, the map creating device 100 analyzes the feature points in the current frame and the prior frame and determines whether the current frame is a key frame (S207). If the relative spatial coordinates of the feature point in the current frame are determined to have been moved a reference range or more from those in the prior frame, the map creating device 100 determines that the current frame is a key frame.

If the current frame is determined to be a key frame, the map creating device 100 determines the relative spatial coordinates of the feature point to minimize the difference between camera pose information predicted from the tracked feature point and camera pose information actually computed from the road image.

Different schemes of determining the spatial coordinates may apply depending on whether the road facility object is a road object or a mid-air object.

The map creating device 100 determines whether the road facility object included in the road image is a road object or a mid-air object based on the properties of the road facility object (S208).

If the road facility object is a road object, the map creating device 100 applies homography transform to at least four coordinate points whose spatial coordinates have already been known in the frame of the road image, thereby determining the spatial coordinates of each road object whose spatial coordinates are not known (S209).

If the road facility object is a mid-air object, the map creating device 100 allows the difference between the camera pose information predicted from the image frame correspondence and the camera pose information actually computed from the road image frame to be minimized and determines the spatial coordinates of each feature point in the road image frame (S210).

Steps S201 to S210 are repeatedly performed on each of the consecutive frames of the road image so that the spatial coordinates of road facility object feature point are determined per frame of the road image.

The map creating device 100, upon recognizing a GCP object, corrects the spatial coordinates of the feature point with respect to the coordinate point whose spatial coordinates has been known in the GCP object (S211). As described above, other various schemes than those described above may apply to correct the spatial coordinates of feature points.

The properties of the road facility objects and corrected spatial coordinates of feature points are transmitted to the map creating server 200, and the map creating server 200 compiles and merge the received information, thereby completing a full high-definition map (S212).

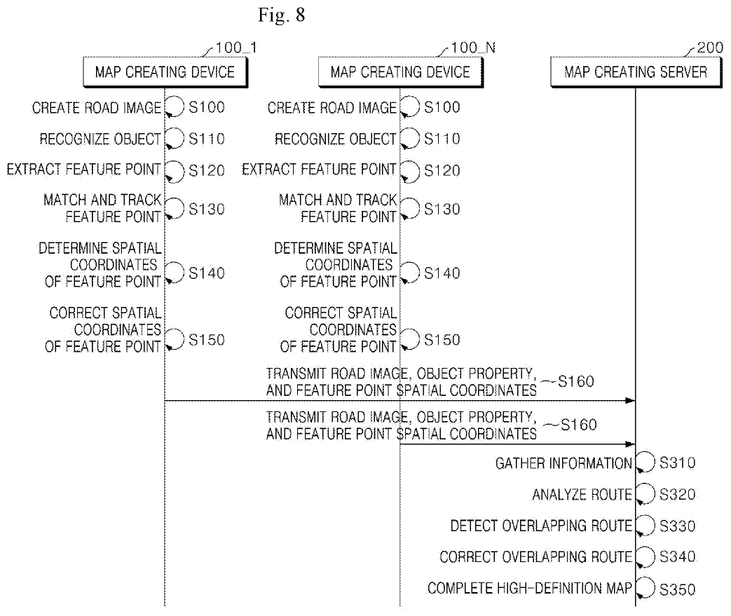

FIG. 8 is a view illustrating information flows in a map creating device and a map creating server according to an embodiment.

Each map creating device 100_1 to 100_n is a device that is mounted in a probe vehicle to create a high-definition map. The map creating device 100_1 to 100_n creates a high-definition map using road images including images of road facility objects captured by the camera fixed to the probe vehicle.

Road image creation (S100), recognition of road facility objects and properties (S110), feature point extraction (S120), feature point matching and tracking (S130), determination of feature point spatial coordinates (S140), and correction of feature point spatial coordinates (S150) are independently performed in each map creating device 100_1 to 100_n. These steps are substantially the same as those described above and, thus, no detailed description thereof is given below.

High-definition road map information and road image created by each map creating device 100_1 to 100_n is transmitted to the map creating server 200 (S160). The high-definition map information includes the properties of each road facility object recognized and the corrected spatial coordinates of the feature point of each road facility object.

The map creating server 200 gathers the road image and high-definition map information from each map creating device 100_1 to 100_n (S310).

Then, the map creating server 200 analyzes the route that at least two or more map creating devices 100_1 to 100_n have passed (S320).

The map creating server 200 detects an overlapping route that overlaps in route and direction from the analyzed route (S330).

The map creating server 200 corrects the spatial coordinates of the feature point of the road facility object preset in the detected overlapping route based on the difference in the spatial coordinates of the feature point determined by each map creating device in the overlapping route (S340).

Lastly, the map creating server 200 gathers and merges the properties of each road facility object and the corrected spatial coordinates of feature points, thereby completing a full high-definition map (S350).

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a controller (e.g., the controller 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A system creating a high-definition map based on a camera, the system comprising at least one or more map creating devices creating a high-definition map using a road image including an image of a road facility object captured by a camera fixed to a probe vehicle, each of the at least one or more high-definition maps comprising:
an object recognizing unit recognizing, per frame of the road image, a road facility object including at least one of a ground control point (GCP) object and an ordinary object and a property;
a feature point extracting unit extracting a feature point of at least one or more road facility objects from the road image;
a feature point tracking unit matching and tracking the feature point in consecutive frames of the road image;
a coordinate determining unit obtaining relative spatial coordinates of the feature point to minimize a difference between camera pose information predicted from the tracked feature point and calculated camera pose information; and
a correcting unit obtaining absolute spatial coordinates of the feature point by correcting the relative spatial coordinates of the feature point based on a coordinate point of the GCP object whose absolute spatial coordinates are known when the GCP object is recognized.

2. The system of claim 1, further comprising a map creating server gathering absolute spatial coordinates of feature point and a property of each road facility object from the at least one or more map creating devices to create the high-definition map.

3. The system of claim 1, wherein each of the at least one or more map creating devices further comprises a key frame determining unit determining that a frame when the relative spatial coordinates of the feature point are moved a reference range or more between consecutive frames of the road image is a key frame and controlling the coordinate determining unit to perform computation only in the key frame.

4. The system of claim 3, wherein the key frame determining unit determines that the same feature point present in a plurality of key frames is a tie point and deletes feature points except for the determined tie point.

5. The system of claim 1, wherein the correcting unit, if the probe vehicle passes again through an area which the probe vehicle has previously passed through, detects a loop route from a route along which the probe vehicle has travelled and corrects absolute spatial coordinates of a feature point of a road facility object present in the loop route based on a difference between absolute spatial coordinates of the feature point determined in the past in the area and absolute spatial coordinates of the feature point currently determined.

6. The system of claim 2, wherein the map creating server analyzes a route which at least two or more probe vehicles have passed through to detect an overlapping route and corrects spatial coordinates of a feature point of a road facility object present in the overlapping route based on a difference between absolute spatial coordinates of the feature point determined by the probe vehicles.

7. The system of claim 1, wherein the road facility object is a road object positioned on a road or a mid-air object positioned in the air, and wherein the coordinate determining unit determines whether the road facility object is the road object or the mid-air object based on a property of the road facility object and obtains absolute spatial coordinates of the road object in each frame of the road image using a homography transform on at least four coordinate points whose spatial coordinates have been known.

8. The system of claim 1, wherein the GCP object includes at least one of a manhole cover, a fire hydrant, an end or connector of a road facility, or a road drainage structure.

9. A method of creating a high-definition map based on a camera, the method creating a high-definition map using a road image including an image of a road facility object captured by a camera fixed to a probe vehicle, the method comprising:
recognizing, per frame of the road image, a road facility object including at least one of a ground control point (GCP) object and an ordinary object and a property;
extracting a feature point of at least one or more road facility objects from the road image;
matching and tracking the feature point in consecutive frames of the road image;
obtaining relative spatial coordinates of the feature point to minimize a difference between camera pose information predicted from the tracked feature point and calculated camera pose information; and
obtaining absolute spatial coordinates of the feature point by correcting the relative spatial coordinates of the feature point based on a coordinate point of the GCP object whose absolute spatial coordinates are known when the GCP object is recognized.

10. The method of claim 9, further comprising gathering, by a map creating server, absolute spatial coordinates of feature point and a property of each road facility object from at least one or more probe vehicles to create the high-definition map.

11. The method of claim 9, further comprising determining that a frame when the relative spatial coordinates of the feature point are moved a reference range or more between consecutive frames of the road image is a key frame and obtaining the relative spatial coordinates and absolute spatial coordinates of the feature point only in the key frame.

12. The method of claim 11, further comprising determining that the same feature point present in a plurality of key frames is a tie point and deleting feature points except for the determined tie point.

13. The method of claim 9, further comprising, if the probe vehicle passes again through an area which the probe vehicle has previously passed through, detecting a loop route from a route along which the probe vehicle has travelled and correcting absolute spatial coordinates of a feature point of a road facility object present in the loop route based on a difference between absolute spatial coordinates of the feature point determined in the past in the area and absolute spatial coordinates of the feature point currently determined.

14. The method of claim 10, further comprising analyzing a route which at least two or more probe vehicles have passed through to detect an overlapping route and correcting spatial coordinates of a feature point of a road facility object present in the overlapping route based on a difference between absolute spatial coordinates of the feature point determined by the probe vehicles.

15. The method of claim 9, wherein the road facility object is a road object positioned on a road or a mid-air object positioned in the air, and wherein the method further comprises determining whether the road facility object is the road object or the mid-air object based on a property of the road facility object and obtaining absolute spatial coordinates of the road object in each frame of the road image using a homography transform on at least four coordinate points whose spatial coordinates have been known.

16. The method of claim 9, wherein the GCP object includes at least one of a manhole cover, a fire hydrant, an end or connector of a road facility, or a road drainage structure.
